(19) United States
(12) Patent Application Publication
(10) Pub. No.: US 2020/0246793 A1
(43) Pub. Date: Aug. 6, 2020

(54) NANOWIRE FET BIOMOLECULE SENSORS WITH INTEGRATED ELECTROOSMOTIC FLOW

(71) Applicant: FemtoDx, Beverly Hills, CA (US)

(72) Inventors: Shyamsunder Erramilli, Quincy, MA (US); Pritiraj Mohanty, Los Angeles, CA (US)

(73) Assignee: FemtoDx, Beverly Hills, CA (US)

(21) Appl. No.: 16/773,786

(22) Filed: Jan. 27, 2020

Related U.S. Application Data
(60) Provisional application No. 62/799,189, filed on Jan. 31, 2019.

(51) Int. Cl. B01L 3/00; G01N 27/414

(52) U.S. Cl. CPC B01L 3/50273; B01L 3/502715; G01N 27/4145; B01L 2300/12; B01L 2300/0627; B01L 2400/0418; B01L 2300/0645

(57) ABSTRACT

The techniques relate to methods and apparatus for electroosmotic flow. A device includes a fluid chamber, at least one sensor element configured to sense an analyte, wherein the at least one sensor element is in fluid communication with the fluid chamber, and a set of electroosmotic electrodes disposed for creating an electroosmotic flow of a fluid in the fluid chamber over the at least one sensor element.

### RELATED APPLICATIONS

This Application claims priority under 35 U.S.C. §119(e) to U.S. Provisional Application Ser. No. 62/799,189, filed Jan. 31, 2019 and entitled “NANOWIRE FET BIOMOLECULE SENSORS WITH INTEGRATED ELECTROOSMOTIC FLOW,” which is hereby incorporated by reference in its entirety.

### FIELD

The techniques described herein relate generally to methods and apparatus for nanochannel-based sensors used to sense chemical or biological species, and in particular to nanowire field-effect transistor (FET) sensors with integrated electroosmotic flow.

### BACKGROUND

Chemical or biological sensors can include nanowires and/or other small-scale electrical devices that essentially serve as sensitive transducers that convert chemical activity of interest into corresponding electrical signals that can be used to accurately represent the chemical activity. The nanosensors can include one or more nanowires (e.g., which may have a tubular form). The nanowires can be fabricated such that once functionalized, their surface will interact with adjacent molecular entities, such as chemical species. The interaction of the nanowires with molecular entities can induce a change in a property (such as conductance) of the nanowire.

### SUMMARY

The inventors have discovered and appreciated that biosensors of analytes in ionic fluids can suffer from significantly reduced sensitivity due to low concentrations of analyte. The inventors have discovered that problems caused by low analyte concentrations of analyte can be overcome by flowing the analyte-containing fluid over the sensor region, so that the effective volume of the solution exposed to the sensor increases compared to a non-flowing configuration. The techniques described herein provide for using a set of electroosmosis-inducing electrodes to create an electroosmotic flow of the solution across the active sensor region. Some embodiments include additional electroosmosis electrodes and/or a channel through which the current created by at least some of the electroosmosis electrodes passes to create electroosmotic flow over the sensor.

Some embodiments relate to a device comprising a fluid chamber, at least one sensor element configured to sense an analyte, wherein the at least one sensor element is in fluid communication with the fluid chamber, and a set of electroosmotic electrodes disposed for creating an electroosmotic flow of a fluid in the fluid chamber over the at least one sensor element.

In some examples, the at least one sensor element comprises at least one semiconductor sensor in electrical communication with a source and a drain.

In some examples, the device further comprises a first contact pad in electrical communication with the source and a second contact pad in electrical communication with the drain.

In some examples, the device further comprises a first electrode connected to the first contact pad and a second electrode connected to the second contact pad.

In some examples, the device further comprises a bias and measurement circuit comprising a voltage source in electrical communication with the first and second electrodes, and a measurement device in electrical communication with the first and second electrodes.

In some examples, the device further comprises four electrodes, wherein a first two of the four electrodes are connected to the first contact pad and the second contact pad, respectively, and a remaining two of the four electrodes are connected to the first contact pad and the second contact pad, respectively.

In some examples, the device further comprises a voltage source in electrical communication with the first two of the four electrodes and a measurement device in electrical communication with the remaining two of the four electrodes.

In some examples, the semiconductor sensor comprises a nanowire Field Effect Transistor (FET) sensor.

In some examples, the set of electroosmotic electrodes comprises a first electroosmotic electrode disposed on a first side of the at least one sensor element, and a second electroosmotic electrode disposed on a second side of the at least one sensor element.

In some examples, the set of electroosmotic electrodes further comprises a third electroosmotic electrode disposed on a third side of the at least one sensor element, and a fourth electroosmotic electrode disposed on the third side.

In some examples, the device further comprises a microfluidic channel. The microfluidic channel can include a set of microfluidic walls that define the microfluidic channel. The set of microfluidic walls can include a first microfluidic wall extending along a first direction, and a second microfluidic wall extending along the first direction and spaced from the first microfluidic wall in a second direction orthogonal to the first direction. The at least one sensor element can be disposed between the first microfluidic wall and the second microfluidic wall. The set of microfluidic walls can include an oxide, a polymer, a metal, or some combination thereof. The microfluidic channel can include a first end disposed on a first side of the at least one sensor element and a second end disposed on a second side of the at least one sensor element, and the set of electroosmotic electrodes can include a first electroosmotic electrode disposed adjacent the first end and a second electroosmotic electrode disposed adjacent the second end.

In some examples, each electrode in the set of electroosmotic electrodes comprises an insulating barrier covering a portion of the electrode.

Some embodiments relate to a method for creating an electroosmotic flow of a fluid in a fluid chamber comprising at least one sensor element configured to sense an analyte in the fluid. The method includes introducing a fluid into the fluid chamber, applying a voltage difference across a set of electroosmotic electrodes disposed in the fluid chamber to create an electroosmotic flow of the fluid over the at least one sensor element, and measuring a resistance of the at least one sensor element.

In some examples, applying the voltage difference includes applying a first voltage to a first electroosmotic electrode of the set of electroosmotic electrodes, and applying a second voltage to a second electroosmotic electrode of the set of electroosmotic electrodes, wherein the first and second voltages comprise different voltages.

In some examples, applying the voltage difference comprises applying an alternating current.

In some examples, applying the voltage difference comprises applying a direct current.

### FIGURES

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1A is a schematic diagram illustrating the use of a sensor device used to detect species in an analyte solution, according to some examples.

FIG. 1B (with views (a)-(d)) depicts a nanochannel-based sensing element that can be used in the circuit of FIG. 1A, according to some examples.

FIG. 1C depicts a sensor employing an array of nanochannels, according to some examples.

FIGS. 1D-1E are exemplary schematic diagrams of a semiconductor-based biomolecular analyte sensor, according to some examples.

FIG. 2A shows a schematic diagram of a general semiconductor-based biomolecular analyte sensor binding to analyte without flow, according to some examples.

FIG. 2B shows a schematic diagram of the general semiconductor-based biomolecular analyte sensor of FIG. 2A binding to analyte with flow, according to some embodiments.

FIG. 3 is a schematic diagram of electroosmotic flow, according to some embodiments. FIGS. 4A-4B are schematic diagrams of top and side views, respectively, of an exemplary biosensor with an electroosmosis channel, according to some embodiments.

FIG. 5 is a schematic diagram of a top view of an exemplary biosensor with an electroosmosis channel and additional electrodes to control fluid flow, according to some embodiments.

FIG. 6 is a diagram illustrating an exemplary design of an integrated biosensor with an electroosmotic microfluidic channel, according to some examples.

### DETAILED DESCRIPTION

Nanochannel-based sensors can be used to detect an analyte in a liquid. The concentration of the analyte can be determined in a controlled environment based on various measurements, such as measurements taken of air, measurements taken using a blank liquid (without the analyte), and measurements taken using a test liquid that may (or may not) contain the analyte. Electrodes can be attached to the nanochannel-based sensors and used to sense characteristics of the sensors. Tthe inventors have discovered and appreciated that while solutions with low analyte concentrations may contain levels of analyte that are desirable to detect, existing techniques may not be able to detect such low analyte concentrations because the fluid is typically not flowing over the sensor, and therefore that the sensor is only exposed to a (small) portion of the analytes in the solution. The techniques described herein provide for creating fluid flow by using an electric field and a micrometer scale channel, which can increase the signal output of biomolecular sensors. Such fluid flow can cause the sensor to detect such low analyte concentrations.

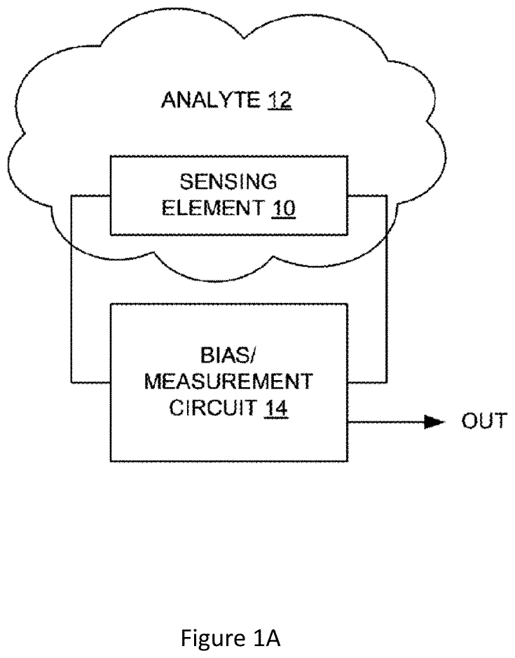

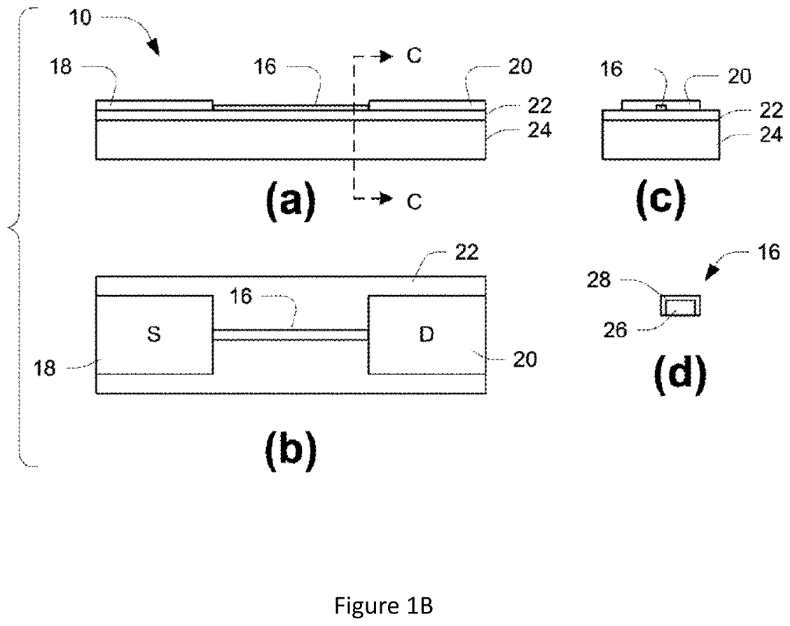

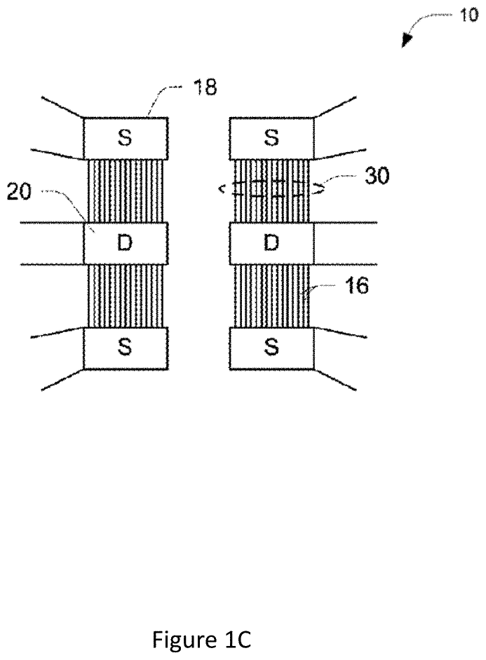

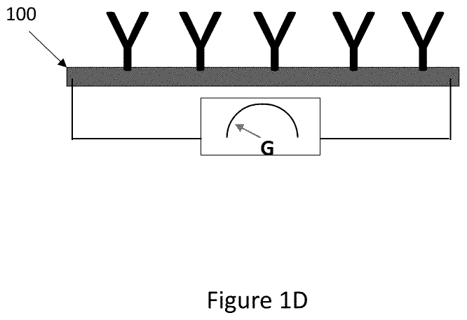

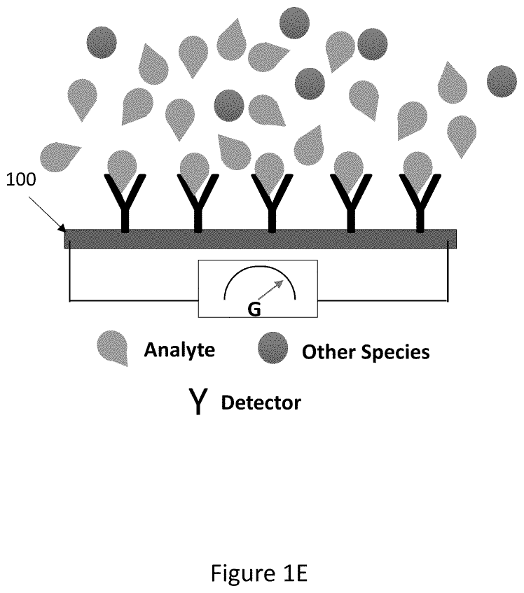

Various types of molecular sensors, such as field effect biomolecule sensors (e.g., including nanowire field effect transistors), can be used to detect biomolecules of interest. In FIG. 1A, a sensing element 10 is exposed to chemical or biological species (analyte) in an analyte solution 12. The sensing element 10 has connections to a bias/measurement circuit 14 that provides a bias voltage to the sensing element 10 and measures the differential conductance of the sensing element 10 (e.g., the small-signal change of conductance with respect to bias voltage). The differential conductance of the device is measured by applying a small modulation of bias voltage to generate a value of an output signal (OUT) that provides information about the chemical or biological species of interest in the analyte solution 12, for example a simple presence/absence indication or a multi-valued indication representing a concentration of the species in the analyte solution 12.

Suitable sensing elements (e.g., including semiconductor nanowires) and sensing technologies have been described in commonly-owned International Publication Number WO 2016/089,453, U.S. Pat. No. 10,378,044 and U.S. Publication No. 2014/0030747, each of which are incorporated herein by reference in their entireties.

The sensing element 12 includes one or more elongated conductors of a semiconductor material such as silicon, which may be doped with impurities to achieve desired electrical characteristics. The dimensions of a channel can be sufficiently small (e.g., nanoscale) such that chemical/electrical activity on the channel surface can have a much more pronounced effect on electrical operation than in larger devices. Such nanoscale channels may be referred to as nanochannels herein. In some embodiments, the sensing element 12 has one or more constituent nanochannels having a cross-sectional dimension of less than about 150 nm (nanometers), and even more preferably less than about 100 nm.

As described herein, the surface of the sensing element 12 can be functionalized by using a series of chemical reactions to incorporate receptors or sites for chemical interaction with the species of interest in the analyte solution 12. As a result of this interaction, the charge distribution, or surface potential, of the surface of the sensing element 12 changes in a corresponding manner. Such a change of surface potential can alter the conductivity of the sensing element 10 in a way that is detected and measured by the bias/measurement circuit 14. Thus, the sensing element 12 can operate as a field-effect device, since the channel conductivity can be affected by a localized electric field related to the surface potential or surface charge density. The measured differential conductance values can be converted into values representing the property of interest (e.g., the presence or concentration of species), based on known relationships as may have been established in a separate calibration procedure, for example.

FIG. 1B shows a sensing element 10 according to one example. As shown in the side view (a) of FIG. 1B, a silicon nanochannel 16 extends between a source (S) contact 18 and a drain (D) contact 20, all formed on an insulating oxide layer 22 above a silicon substrate 24. Top view (b) of FIG. 1B shows the narrow elongated nanochannel 16 extending between the wider source and drain contacts 18, 20, which are formed of a conductive material such as gold-plated titanium for example. View (c) of FIG. 1B shows the cross-sectional view in the plane C-C of view (a). View (d) of FIG. 1B shows the cross section of the nanochannel 16 in more detail. In the illustrated embodiment, the nanochannel 16 includes an inner silicon member 26 and an outer oxide layer 28 such as aluminum oxide.

FIG. 1C shows a sensing element 10 employing an array of nanochannels 16, which in the illustrated example are arranged into four sets 30, each set including approximately twenty parallel nanochannels 16 extending between respective source and drain contacts 18, 20. By utilizing arrays of nanochannels 16 such as shown, greater signal strength (current) can be obtained, which can improve the signal-to-noise ratio of the sensing element 10. To obtain fully parallel operation, the source contacts 18 are all connected together by separate electrical conductors, and likewise the drain contacts 20 are connected together by separate electrical conductors. Other configurations are of course possible. For example, each set 30 may be functionalized differently so as to react to different species which may be present in the analyte solution 12, enabling an assay-like operation. In such configurations, it should be understood that each set 30 has separate connections to the bias/measurement circuit 14 to provide for independent operation.

The sensing element 10 may be made by a variety of techniques employing generally known semiconductor manufacturing equipment and methods. In some embodiments, Silicon-on-Insulator (SOI) wafers are employed. A starting SOI wafer may have a device layer thickness of 100 nm and oxide layer thickness of 380 nm, on a 600 μm boron-doped substrate, with a device-layer volume resistivity of 10-20 Ω-cm. After patterning the nanochannel channels and the electrodes (e.g., in separate steps), the structure can be etched out with an anisotropic reactive-ion etch (RIE). This process can expose the three surfaces (top and sides) of the silicon nanochannels 16 along the longitudinal direction, resulting in increased surface-to-volume ratio. A layer of AL₂O₃ (e.g., approximately 5 to 15 nm thick) can be grown using atomic layer deposition (ALD). Selective response to specific biological or chemical species can be realized by fabricating the nanochannels 16 such that once functionalized, the nanochannels 16 react to one or more analytes. In use, a flow cell, such as a machined plastic flow cell, can be employed. For example, a machined plastic flow cell can be fitted to the device and sealed with silicone gel, with the sensing element 10 bathed in a fluid volume (of about 30 μL for example), connected to a syringe pump.

In some embodiments, the sensing element 10 may include other control elements or gates adjacent to the nanochannels 16. For example, the sensing element 10 can include a top gate, which can be a conductive element formed along the top of each nanochannel 16. Such a top gate may be useful for testing, characterization, and/or in some applications during use, to provide a way to tune the conductance of the sensing element in a desired manner. As another example, the sensing element 10 may include one or more side gates formed alongside each nanochannel 16 immediately adjacent to the oxide layer 28, which can be used for similar purposes as a top gate. As a further example, in some embodiments the sensing element 10 can include a temperature sensor (e.g., disposed near the nanochannels). The system can use measurements from the temperature sensor to modify the system operations. For example, the circuitry can be configured to adjust how the system maps measured nanowire conductances to the concentration of an analyte.

Large biomolecules, such as proteins or virus fragments (e.g., which can include nanoparticles, with size ranging from 10-5000 nm), can be considered dielectric nanoparticles. In some embodiments, the biomolecules are naturally uncharged. In certain embodiments, the biomolecules are charged, and attract free ions in solution to become effectively neutral. In such embodiments, the size of the dielectric particle is increased from the size of the bare particle by the Debye length, e.g., typically on the order of 1-10 nm.

Field effect biomolecule sensors, such as the nanowire field effect transistors described in conjunction with FIGS. 1A-1C, as well as other molecular sensors, can be used to detect biomolecules of interest. Such molecular detection, where the presence of a specific molecule can be determined, can be useful for a variety of applications, including cancer detection, disease verification, and other medical and biological applications. In some embodiments, the sensor component consists of a binding molecule attached to the surface of a substrate material. In some embodiments, the substrate is patterned into nanowires as described above. In some embodiments, the substrate material is silicon, germanium, a III-V semiconductor, and/or the like. In some embodiments, the material is a carbon nanotube. In some embodiments, the material is graphene. It should be appreciated that the techniques described herein can be used with various substrate materials. Some examples are described herein in the context of a semiconductor nanowire FET sensor, but it should be understood that the techniques can be applied to other sensor types.

The binding molecules, which can also be referred to as detectors, can be designed to be particle-specific, such that only one specific particle (the analyte) will bind to a given detector. In some embodiments, the detector is an antibody. In some embodiments, the detector is a DNA or RNA fragment. In some embodiments, the analyte is a protein. In some embodiments, the analyte is a virus particle. It should be appreciated that the techniques described herein can be used in conjunction with any possible detector and analyte species combinations.

FIGS. 1D-1E are schematic diagrams of a general semiconductor-based biomolecular analyte sensor, according to some embodiments. As shown in FIG. 1E, binding of the specific analyte to the detector molecule results in a change in resistance of the semiconductor 100 relative to the bare state, as shown in FIG. 1D. When the analyte binds to the detector, it is held close to the substrate and no longer migrates within the fluid containing the analyte and other species. The binding of the analyte causes a measurable change in physical properties of the semiconductor. In some embodiments, a measured resistance (or conductance) change ΔR (or ΔG) indicates the presence of the analyte, as illustrated in FIG. 1D (showing R0) and 1E (showing R0+ΔR). In some embodiments, the analyte charge, within the Debye length, causes the change in conductivity. In some embodiments, structural changes in the detector molecule upon binding cause the measurable changes. In certain embodiments, the change is due to electrical gating by the analyte. In some embodiments, the change is due to a change in the surface plasmon resonance. In some embodiments, the conductance change can be generally detected electrically by applying an electric current to the sensor and measuring a change in voltage. In some embodiments, the change is detected optically. In certain embodiments, binding can be detected mechanically. Our electroosmotic flow invention is general to all molecular binding-based detectors and covers all detection mechanisms. Some examples described herein address nanowire-patterned substrates with physical property changes that are detected electrically, through a change in conductance, although it should be understood the techniques are not limited to such examples.

A challenge to biosensor development can include obtaining a sufficient signal amplitude when measuring for the presence of analytes. The signals that can be used to determine molecular presence can generally depend on the total number of analytes that bind to detectors. Analytes in fluids such as blood may occur at a concentration too low to detect using existing sensors, but still at levels of interest for, e.g., medical diagnosis. Additionally, high concentrations of other particles may interfere with the analytes approaching the detector. When the concentration is too low, the low concentration can cause binding to occur at very few sites, which in-turn can only causes an immeasurable change (e.g., often within the systematic noise) in the nanowire properties. This can be further compounded by other particles in the solution.

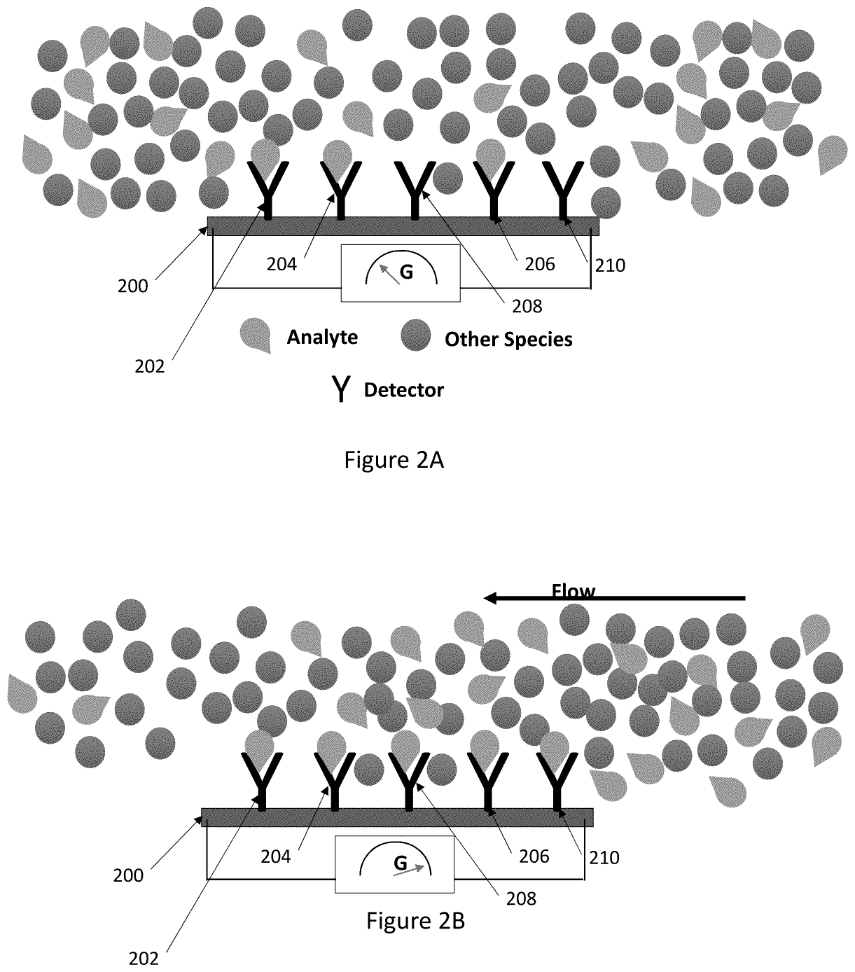

FIG. 2A shows a schematic diagram of a general semiconductor-based biomolecular analyte sensor 200 binding to analyte without flow, according to some examples. The sensor 200 is only exposed to the region of the fluid near the sensor, and the analyte concentration in that area becomes depleted due to analytes binding to the receptors 202, 204 and 206, such that receptors 208 and 210 do not bind to analytes. Therefore, if the fluid is static (e.g., as shown in FIG. 2A), only analytes within the small volume near the sensor interact with the sensor. When the analytes in that area of the solution bind, the fluid region becomes depleted of analytes, and the signal can become saturated. Therefore, the analyte concentration can be low enough such that not all binding sites on the sensor are occupied. Since there are typically analyte in other areas, the signal can be limited by the effective fluid volume allowed to interact with the sensor.

The inventors have therefore determined that it can be desirable to increase the total effective fluid volume that interacts with the sensor (e.g., interacts with the sensor detectors). Increasing the fluid volume that interacts with the sensor can allow for a greater number of analyte molecules to come into contact with the sensor and increase the measured signal. A fluid sample is typically significantly larger than the effective sensor region volume (e.g., the area/volume that includes the detectors). Since the total number of anlytes in a large fluid sample can be much larger than the number of analytes at or near the sensor detector volume, enough analyte particles may exist in a full sample to be detectable, even if the local concentration is too low for detection. Simply making the sensor region larger, for example by making the sensor longer and/or wider, may be prohibitive, such as from a manufacturing standpoint (e.g., prohibitively long nanofabrication) and/or from a signal standpoint (e.g., longer sensors can give larger background resistance and poor noise characteristics).

The inventors have therefore developed techniques to increase the total fluid volume that interacts with the sensor (e.g., without needing to increase the size of the sensor region), which can increase detectable signals to usable levels. Some embodiments provide for creating electroosmotic flow in a microchannel within which the sensor is located. As the fluid flows in the microchannel across the sensor region, the sensor can be exposed to more of and/or the total volume of fluid. If the flow is not too strong so as to dislocate the analytes from the sensor, the total number of analytes that bind to the detectors will increase. The flow effectively moves the depleted region (e.g., with less analytes due to those analytes binding to receptors) from directly above the sensor to downstream from the sensor, and replenishes the fluid near the sensor with fluid with higher analyte concentration. This is illustrated in FIG. 2B, which shows a schematic diagram of the general semiconductor-based biomolecular analyte sensor 200 of FIG. 2A binding with flow, according to some embodiments. With flow, the fluid around the sensor 200 can be moved and/or replenished (e.g., in a continuous manner), such that the analyte-depleted region after binding can be moved away from the sensor. In this example, the fluid flow results in each of detectors 202-210 binding to analyte.

Electroosmosis refers to related effects whereby a charge-neutral fluid containing ions can be driven to flow near the proximity of a surface. The surface typically contains free charges that attract ions in the fluid, creating a charged region near the surface. In some embodiments, a single surface is used. In some embodiments, two or more surfaces are used to create a channel or tube for electroosmosis. In some embodiments, the surface(s) are a dielectric such as glass. In some embodiments, the surface(s) are polymeric materials. The techniques described herein can use any type of surface material(s) and surface/channel geometries to achieve electroosmosis. In some embodiments, the electroosmotic channel surface can be the same surface as the boundary of a fluid chamber that holds the fluid for exposure to the sensor.

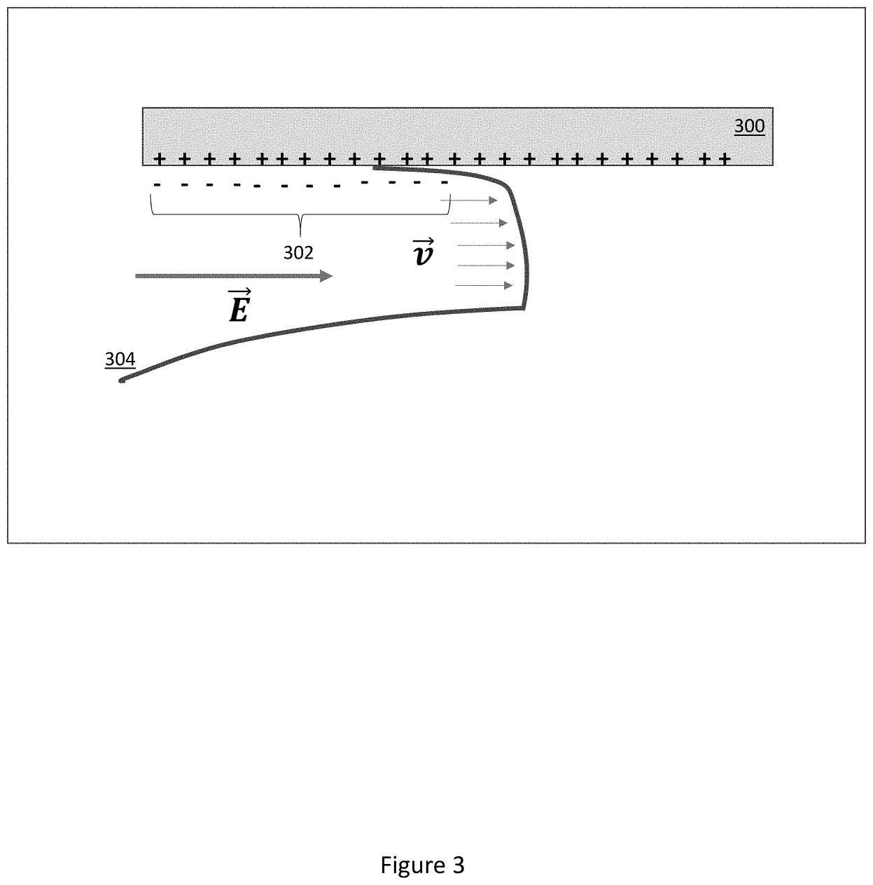

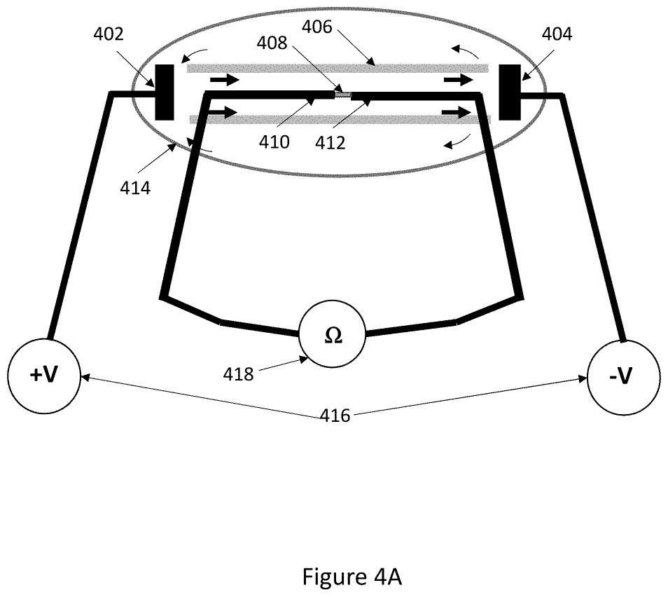

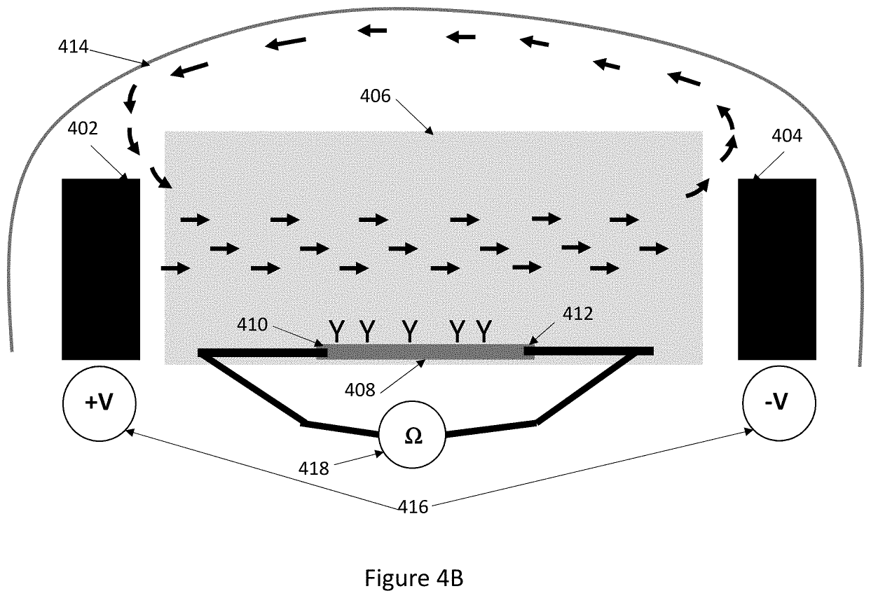

When an electric field is applied to the fluid near the surface, the fluid moves due to electrostatic forces. FIG. 3 is a schematic diagram illustrating electroosmotic flow, according to some embodiments. A surface 300 with a charge density (e.g., shown in this example as a positive charge density) attracts opposite ions from the solution 304 (e.g., shown as attracting negative ions, in this example), creating a charged region 302 in the fluid near the surface. An electric field can be used to drive the charges, and hence cause the fluid to flow. Flow velocity can be larger in regions of the fluid near the surface, and can decrease in portions of the fluid that are farther from the surface.

In some embodiments, the velocity \vec{v} near the surface can be calculated using Equation 1:

$$\vec{v} = \frac{{ϵζ}_{0}}{η} \vec{E} \qquad Equation 1$$

Where:

ϵ is the fluid's dielectric constant,

ζ₀ is the zeta potential related to the ionic concentration, and

E is the applied electric field.

Equation 1 is provided for exemplary purposes, as some embodiments can use a different velocity form to determine the velocity near the surface. In some embodiments, the fluid velocity can be monotonically dependent on the applied electric field. In some embodiments, the surface charge and ionic concentrations are such that the zeta potential is positive and flow is parallel to the field. In other embodiments, the zeta potential is negative and flow is antiparallel to the field.

Different types of electric fields can be used to create electroosmotic flow. In some embodiments, the electric field does not change in a predictable manner based on time, and is therefore time-independent (e.g., when using direct current (DC)). In some embodiments, the electric field oscillates at a certain frequency to create oscillating flow (e.g., when using an alternating current (AC)). In some embodiments, the device can operate at any frequency in which electroosmotic flow dominates over other flow patterns, such as electrophoresis. In some embodiments, the electric field is sinusoidally varying in time. In some embodiments, the electric field is pulsed.

In some embodiments, the electroosmotic force only acts within a certain vicinity of the surface, as shown in FIG. 3 at 302, depending on the surface 300 and qualities of the fluid 304. Electroosmotic flow velocity can (e.g., rapidly) decrease away from this vicinity. In some embodiments, flow may only occur within a small distance (e.g., with a few microns) of the surface. In some embodiments, flow can occur within a few millimeters of the surface.

Electroosmosis can create flow through otherwise static regions. For example, at the ends of the surface, the moving fluid enters the more static part of the fluid and can create a continuous flow. FIGS. 4A-4B are schematic diagrams of top and side views, respectively, of a biosensor with an electroosmosis channel, according to some embodiments. FIGS. 4A-4B show the electroosmosis electrodes 402, 404, the microfluidic channel 406, nanowire FET biosensor 408 with detection electrodes 410-412, fluid containing the biomolecules to be detected (shown as a bounding ovate line 414, which can be a fluid chamber), and external equipment (not shown) that is used to apply voltages 416 and measure resistances 418. A voltage difference is applied across the two electroosmosis electrodes 402 and 404, which creates current flow in the microfluidic channel 406. Fluid flow is denoted with arrows. Fluid exiting the channel above and to the sides of the microfluidic channel 406 re-enters the bulk of the fluid. As described herein, the fluid can flow continuously while a voltage difference is applied using the electroosmosis electrodes 402 and 404.

In some embodiments the electric field is applied by applying a voltage to metallic electrodes integrated on the microchip. In some embodiments, the electric field is applied with external electrodes. The techniques described herein are not limited in terms of electrode geometries that create electroosmotic flow for the purposes increasing biosensor sensitivity. As the fluid moves across the sensor, the fluid volume in the vicinity of the sensor can be continually replenished. The total number of analyte molecules available to bind to the sensor thereby increases as the fluid volume with depleted analytes due to binding is replaced with portions of the fluid with higher analyte concentration.

In some embodiments, as shown in FIGS. 4A-4B for example, some exemplary designs can combine a sensor with a microfluidic electroosmosis channel. The sensor can be located in the center of a fluidic chamber. The fluidic chamber may be of any size or shape, such as an ellipsoid shape as shown in FIG. 4A-4B that encloses the fluid. As described herein, electrodes connect the sensor to metal pads, which connect to measurement electronics for the purposes of detecting conductance changes. In some embodiments, the sensor can use a 2-point electrical measurement technique, where the electrodes that apply the voltage are the same electrodes that are used to measure conductance. In some embodiments, the sensor can use a 4-point measurement technique, where different sets of voltage electrodes and conductance measurement electrodes are used (e.g., where the conductance measurement electrodes are disposed close to the sensor 408). In some embodiments, the sensor utilizes a differential measurement. It should be appreciated that the techniques described herein are not limited to any particular sensor measurement technique. A microfluidic channel is created so that the sensor is in the center of the channel.

The channel can be disposed in one or more directions with respect to the electrodes and/or sensor nanowires. In some embodiments, the channel is parallel to the electrodes. In some embodiments, the channel is perpendicular to the electrodes. In some embodiments, flow is perpendicular to the nanowires. In some embodiments, flow is parallel to the nanowires. In some embodiments, the flow is at an angle to the nanowire orientation.

In some embodiments, the channel is composed of metal, semiconductor, or insulating walls that can be defined lithographically and deposited on the substrate. In some embodiments, the sensor is patterned in an etched channel. In some embodiments, the channel is curved. The techniques described herein are not limited in terms of channel shapes and sizes. In some embodiments, the channel walls are gated to control the effective surface charge and, therefore, flow rate.

In some embodiments, metal electrodes are disposed at each end of the channel, which are electrically connected to voltage source(s) outside of the fluid region. A voltage difference can be applied across the electrodes, such that one electrode is fixed at voltage V1 and the other at a different voltage V2, with a voltage difference V2−V1. For exemplary purposes, FIG. 4 shows a channel with +V applied at one electrode and −V applied at the other electrode. The voltage difference can be DC or AC at any frequency below the onset of electropheresis.

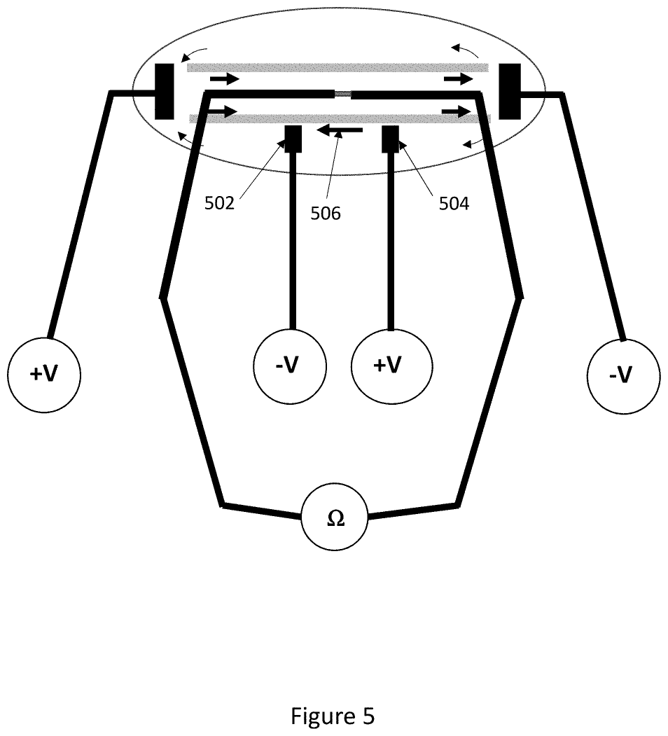

In some embodiments, additional electrodes can be added at one or more other points (e.g., inside the channel) to increase flow within the channel. In some embodiments, additional electrodes can be added (e.g., outside the channel) to induce continuous flow outside the channel. FIG. 5 is a schematic diagram of a top view of a biosensor with an electroosmosis channel (e.g., as shown in FIGS. 4A-4B) with additional electroosmosis electrodes 502 and 504 to control fluid flow, according to some embodiments. The additional electroosmosis electrodes 502 and 504 can be used to control fluid flow in other regions, such as enhancing the backflow of the fluid along the outside of the microfluidic chamber as shown by arrow 506.

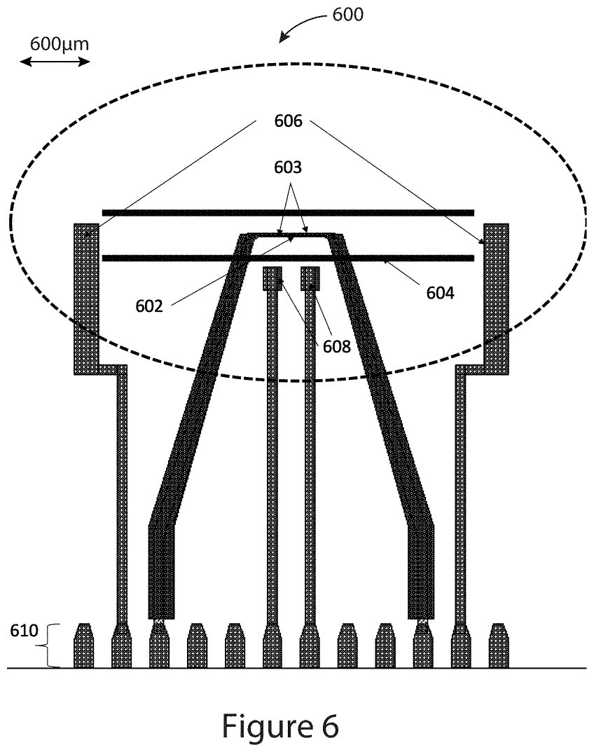

FIG. 6 shows a top-view schematic 600 of an exemplary microchannel-sensor configuration, according to some embodiments. The complete device consists of the sensor including the sensor region 602 and its associated electrodes 603, a microfluidic channel 604, and electroosmotic electrodes 606 to control the electroosmotic flow. Various techniques can be used to build a sensing device in accordance with the techniques described herein, which can consist of various process steps. In some embodiments, the electroosmosis-controlling electrodes 606 can be placed during the same process step as that which places the final electrode pads for the sensor electrodes (e.g., and can be made of the same material). In some embodiments, the electroosmosis electrodes are placed in a different step than the step(s) used to place the final sensor electrode pads. In some embodiments, the electroosmosis electrodes are coated with an insulating barrier in regions away from the microfluidic channel. In the example shown in FIG. 6, additional electrodes 608 are included to further control the flow as described herein, although it should be appreciated that embodiments may not include electrodes 608 and/or may include further electrodes as described herein. For example, some embodiments can include more electrodes than those shown in FIG. 6, which can allow for further flow control in the fluid volume (e.g., ultraprecise flow control). As shown in region 610, the various electrodes 603, 606 and 608 attach to metal pads that allow for connection to external source and/or devices, such as external voltage and current sources.

The electrodes can comprise various sizes. In some embodiments, the electrodes are about 1 micron thick. In some embodiments, the electrodes are thinner, ranging from approximately 10-1000 nm thick. In some embodiments the electrodes are thicker, ranging from approximately 1-10 microns thick.

In some embodiments, microfluidic channel walls can be formed as part of the device. For example, in addition to the electroosmosis electrodes, microfluidic channel walls described herein can be defined by depositing two insulating layers in the shape of parallel lines. As shown in FIGS. 4-6, for example, the lines of the microfluidic channel can be formed with the sensor disposed in the middle of the lines. In some embodiments, the lines are made of an oxide, such as Al₂O₃ or SiO₂. In some embodiments, the lines are made of a polymer material. In some embodiments, the lines are metal coated in an oxide or polymer layer. In some embodiments, a voltage can be applied to the lines (e.g., metal lines) to control current flow along the wall.

Various computer systems can be used to perform any of the aspects of the techniques and embodiments disclosed herein. The computer system may include one or more processors and one or more non-transitory computer-readable storage media (e.g., memory and/or one or more non-volatile storage media) and a display. The processor may control writing data to and reading data from the memory and the non-volatile storage device in any suitable manner, as the aspects of the invention described herein are not limited in this respect. To perform functionality and/or techniques described herein, the processor may execute one or more instructions stored in one or more computer-readable storage media (e.g., the memory, storage media, etc.), which may serve as non-transitory computer-readable storage media storing instructions for execution by the processor.

In connection with techniques described herein, code used to, for example, provide the techniques described herein may be stored on one or more computer-readable storage media of computer system. Processor may execute any such code to provide any techniques for planning an exercise as described herein. Any other software, programs or instructions described herein may also be stored and executed by computer system. It will be appreciated that computer code may be applied to any aspects of methods and techniques described herein. For example, computer code may be applied to interact with an operating system to plan exercises for diabetic users through conventional operating system processes.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

Various aspects are described in this disclosure, which include, but are not limited to, the above-described aspects.

1. A device comprising:
a fluid chamber;
at least one sensor element configured to sense an analyte, wherein the at least one sensor element is in fluid communication with the fluid chamber; and
a set of electroosmotic electrodes disposed for creating an electroosmotic flow of a fluid in the fluid chamber over the at least one sensor element.

2. The device of claim 1, wherein the at least one sensor element comprises at least one semiconductor sensor in electrical communication with a source and a drain.

3. The device of claim 2, further comprising a first contact pad in electrical communication with the source and a second contact pad in electrical communication with the drain.

4. The device of claim 3, further comprising a first electrode connected to the first contact pad and a second electrode connected to the second contact pad.

5. The device of claim 4, further comprising a bias and measurement circuit comprising:
a voltage source in electrical communication with the first and second electrodes; and
a measurement device in electrical communication with the first and second electrodes.

6. The device of claim 3, further comprising four electrodes, wherein a first two of the four electrodes are connected to the first contact pad and the second contact pad, respectively, and a remaining two of the four electrodes are connected to the first contact pad and the second contact pad, respectively.

7. The device of claim 6, further comprising:
a voltage source in electrical communication with the first two of the four electrodes; and
a measurement device in electrical communication with the remaining two of the four electrodes.

8. The device of claim 2, wherein the semiconductor sensor comprises a nanowire Field Effect Transistor (FET) sensor.

9. The device of claim 1, wherein the set of electroosmotic electrodes comprises:
a first electroosmotic electrode disposed on a first side of the at least one sensor element; and
a second electroosmotic electrode disposed on a second side of the at least one sensor element.

10. The device of claim 9, wherein the set of electroosmotic electrodes further comprises:
a third electroosmotic electrode disposed on a third side of the at least one sensor element; and
a fourth electroosmotic electrode disposed on the third side.

11. The device of claim 1, further comprising a microfluidic channel.

12. The device of claim 11, wherein the microfluidic channel comprises a set of microfluidic walls that define the microfluidic channel.

13. The device of claim 12, wherein the set of microfluidic walls comprises:
a first microfluidic wall extending along a first direction; and
a second microfluidic wall extending along the first direction and spaced from the first microfluidic wall in a second direction orthogonal to the first direction.

14. The device of claim 12, wherein the at least one sensor element is disposed between the first microfluidic wall and the second microfluidic wall.

15. The device of claim 12, wherein the set of microfluidic walls comprise an oxide, a polymer, a metal, or some combination thereof.

16. The device of claim 11, wherein:
the microfluidic channel comprises a first end disposed on a first side of the at least one sensor element and a second end disposed on a second side of the at least one sensor element; and
the set of electroosmotic electrodes comprises a first electroosmotic electrode disposed adjacent the first end and a second electroosmotic electrode disposed adjacent the second end.

17. The device of claim 1, wherein each electrode in the set of electroosmotic electrodes comprises an insulating barrier covering a portion of the electrode.

18. A method for creating an electroosmotic flow of a fluid in a fluid chamber comprising at least one sensor element configured to sense an analyte in the fluid, the method comprising:
introducing a fluid into the fluid chamber;
applying a voltage difference across a set of electroosmotic electrodes disposed in the fluid chamber to create an electroosmotic flow of the fluid over the at least one sensor element; and
measuring a resistance of the at least one sensor element.

19. The method of claim 18, wherein applying the voltage difference comprises:
applying a first voltage to a first electroosmotic electrode of the set of electroosmotic electrodes; and
applying a second voltage to a second electroosmotic electrode of the set of electroosmotic electrodes, wherein the first and second voltages comprise different voltages.

20. The method of claim 18, wherein applying the voltage difference comprises applying an alternating current.

21. The method of claim 18, wherein applying the voltage difference comprises applying a direct current.
